(19) United States
(12) Patent Application Publication
(10) Pub. No.: US 2011/0304678 A1
(43) Pub. Date: Dec. 15, 2011

(54) LIQUID EJECTING APPARATUS

(75) Inventor: Taisuke Yamamoto, Shiojiri-shi (JP)

(73) Assignee: SEIKO EPSON CORPORATION, Tokyo (JP)

(21) Appl. No.: 13/159,249

(22) Filed: Jun. 13, 2011

(30) Foreign Application Priority Data
Jun. 15, 2010 (JP) 2010-135841

(51) Int. Cl. B41J 2/175

(52) U.S. Cl. 347/93

(57) ABSTRACT

A liquid ejecting apparatus includes a liquid ejecting head that ejects liquid through nozzles, a liquid accommodating portion which accommodates the liquid to be supplied to the liquid ejecting head, and a filter chamber which is arranged in a liquid supply path between the liquid ejecting head and the liquid accommodating portion and includes a filter. In the liquid ejecting apparatus, the filter is rotatable in the filter chamber between a first state in which the liquid passes through the filter and a second state in which the liquid flows along the filter.

### CROSS REFERENCES TO RELATED APPLICATIONS

The entire disclosure of Japanese Patent Application No. 2010-135841, filed Jun. 15, 2010 is expressly incorporated by reference herein.

### BACKGROUND

1. Technical Field

The present invention relates to a liquid ejecting apparatus.

2. Related Art

An exisiting ink jet printer (hereinafter, referred to as “printer”) has been widely known as a liquid ejecting apparatus which ejects ink droplets onto a recording sheet (medium). In such printer, a filter for preventing air bubbles from entering an ink flow path of a recording head is provided (for example, see JP-B-07-51355 and JP-A-52-150027).

A filter having high capturing performance and a low flow path resistance has been needed as functions thereof. However, there has been a problem in that if air bubbles are accummulated on the filter over time, the flow path resistance is increased and ink cannnot be preferably supplied to the flow path.

### SUMMARY

An advantage of some aspects of the invention is to provide a liquid ejecting apparatus which prevents increase in a flow path resistance due to accumulation of air bubbles.

A liquid ejecting apparatus according to an aspect of the invention includes a liquid ejecting head which ejects liquid through nozzles, a liquid accommodating portion which accommodates the liquid to be supplied to the liquid ejecting head, and a filter chamber which is arranged in a liquid supply path between the liquid ejecting head and the liquid accommodating portion and includes a filter. In the liquid ejecting apparatus according to the aspect of the invention, it is preferable that the filter be rotatable in the filter chamber between a first state in which the liquid passes through the filter and a second state in which the liquid flows along the filter.

With the liquid ejecting apparatus according to the aspect of the invention, air bubbles in liquid can be trapped in the first state where the liquid passes through the filter. Further, if the filter is made into the second state in which the liquid flows along the filter, air bubbles attached to the filter can be easily discharged to the outside. Further, the filter is rotated so as to be easily switched between the first state and the second state. Therefore, failure in which a flow path resistance in the head is increased due to accumulation of air bubbles on the filter and the liquid is not supplied to the liquid ejecting head can be prevented from occurring.

Further, it is preferable that the liquid ejecting apparatus according to the aspect of the invention include a discharge unit which is arranged between the filter and the liquid ejecting head and discharges the liquid which has flown along the filter from the filter chamber in the second state.

With the configuration, air bubbles attached to the filter can be reliably discharged.

Further, in the liquid ejecting apparatus according to the aspect of the invention, it is preferable that the discharge unit discharge liquid without passing through nozzles of the liquid ejecting head.

With this configuration, since air bubbles which have flown along the filter do not pass through the nozzles of the liquid ejecting head, a problem that the air bubbles stay in a flow path from the filter to the nozzles and discharge failure is caused thereafter can be suppressed from occurring. In addition, since the air bubbles do not pass through a narrow flow path and without passing through the nozzles, the air bubbles can be discharged more easily.

Further, in the liquid ejecting apparatus according to the aspect of the invention, it is preferable that the discharge unit include a suction pump which decompresses an inner portion of the filter chamber to suck the liquid in the second state.

With this configuration, air bubbles attached to the filter can be reliably discharged with a suction force by the suction pump.

Further, it is preferable that the liquid ejecting apparatus according to the aspect of the invention include a pressurizing mechanism which applies a pressurizing force to the liquid accommodated in the liquid accommodating portion and the discharge unit discharge the liquid from the filter chamber by using the pressurizing force by the pressurizing mechanism in the second state.

With this configuration, air bubbles can be discharged by using a pressurizing force by the pressurizing mechanism. Therefore, the configuration of the discharge unit can be simplified.

Further, it is preferable that the liquid ejecting apparatus according to the aspect of the invention include an abutment unit which abuts against a nozzle formation surface of the liquid ejecting head on which the nozzles are formed in the second state.

With this configuration, a discharge operation of air bubbles by the discharge unit is performed in a state where the abutment member abuts against the nozzle formation surface to close a liquid flow path in the head. Therefore, the liquid in the nozzles can be prevented from being drawn to the inner side and meniscuses of the nozzles can be prevented from being broken.

Further, in the liquid ejecting apparatus according to the aspect of the invention, it is preferable that a suction force by the suction pump be set to be equal to or lower than a meniscus withstanding pressure of the nozzles.

With this configuration, a suction force by the suction pump is set to be equal to or lower than a meniscus withstanding pressure of the nozzles. Therefore, breakage of the meniscuses of the nozzles due to the discharge operation by the suction pump can be prevented from occurring.

Further, in the liquid ejecting apparatus according to the aspect of the invention, it is preferable that a pressurizing force by the pressurizing mechanism be set to be equal to or lower than a meniscus withstanding pressure of the nozzles.

With this configuration, a pressurizing force by the pressurizing mechanism is set to be equal to or lower than a meniscus withstanding pressure of the nozzles. Therefore, breakage of the meniscuses of the nozzles due to the discharge operation by the discharge unit can be prevented from occurring.

### BRIEF DESCRIPTION OF THE DRAWINGS

The invention will be described with reference to the accompanying drawings, wherein like numbers reference like elements.

FIG. 1 is a plan view illustrating an entire configuration of a printer according to the embodiment.

FIG. 2 is a cross-sectional view for explaining a configuration of a recording head in the printer according to the embodiment.

FIG. 3 is a plan view schematically illustrating a configuration of main parts around the recording head according to the embodiment.

FIG. 4 is a view illustrating an arrangement state of a filter.

FIG. 5 is a block diagram illustrating an electric configuration of the printer.

FIG. 6 is a view illustrating an operation state of the filter.

FIG. 7 is a schematic view illustrating a configuration of an abutment unit.

FIG. 8 is a view illustrating a schematic configuration of an ink flow path system of a printer according to a variation.

FIG. 9 is a view illustrating a configuration in an ink cartridge of the printer according to the variation.

### DESCRIPTION OF EXEMPLARY EMBODIMENTS

Hereinafter, an embodiment of the invention is described with reference to drawings. In the drawings used in the following description, scales of members are appropriately changed in order to make the members be recognizable sizes.

At first, a printer as an embodiment of a liquid ejecting apparatus according to the invention is described.

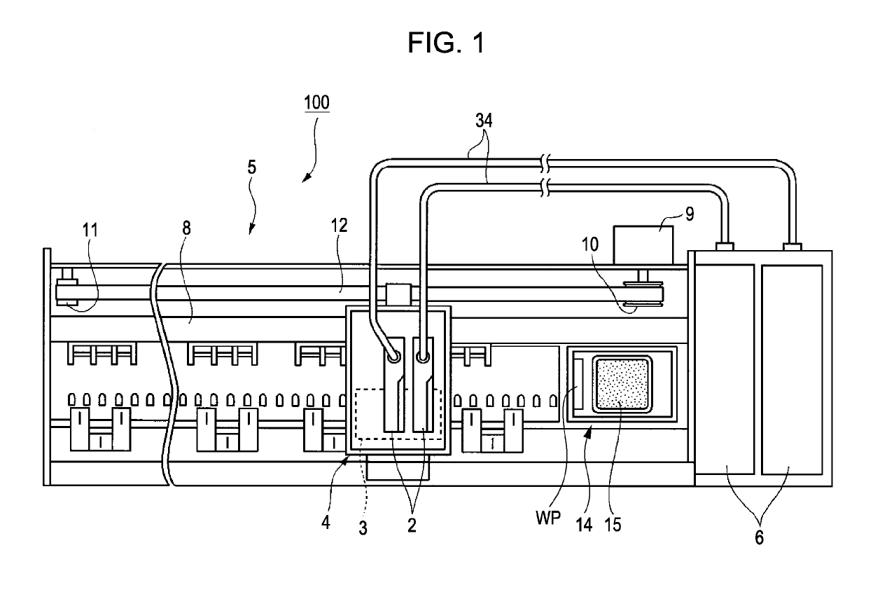

FIG. 1 is a plan view illustrating an entire configuration of a printer.

A printer 100 according to the embodiment is schematically configured to include a printer main body 5, ink cartridges 6, and a carriage 4 on which sub tanks (liquid accommodating portions) 2 and a recording head 3 (liquid ejecting head) are mounted.

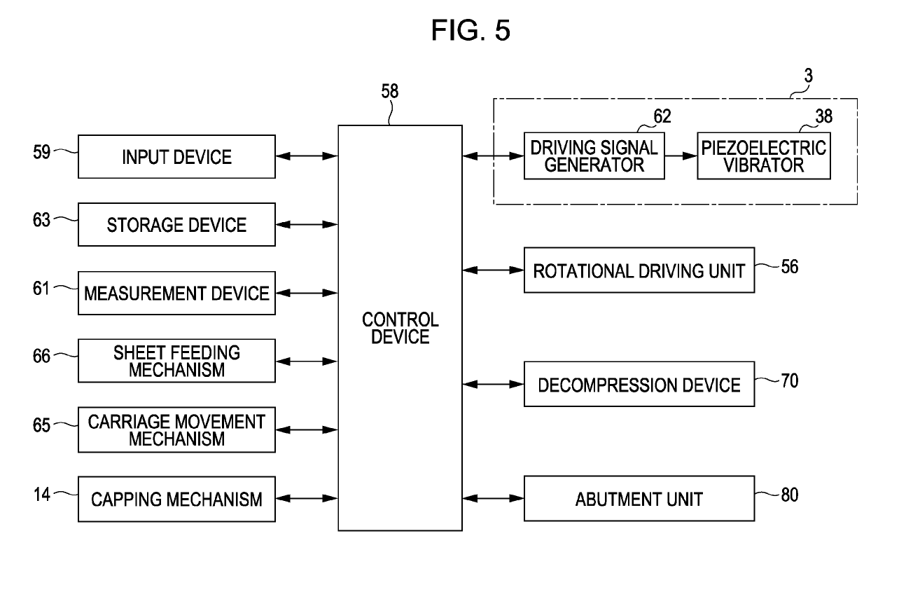

A carriage movement mechanism 65 (see, FIG. 5), a sheet feeding mechanism 66 (see, FIG. 5), a capping mechanism 14, a wiping member WP, and the ink cartridges 6 are provided in the printer main body 5. The carriage movement mechanism 65 reciprocates the carriage 4. The sheet feeding mechanism 66 transports a recording sheet (not shown). The capping mechanism 14 is used for a cleaning processing of the recording head 3. The wiping member WP is used for a wiping processing of the recording head 3. The ink cartridges 6 store (accommodate) ink to be supplied to the recording head 3.

The carriage movement mechanism 65 is constituted by a guiding shaft 8, a pulse motor 9, a driving pulley 10, an idling pulley 11, and a timing belt 12. The guiding shaft 8 is bridged in the printer main body in the width direction. The driving pulley 10 is connected to a rotational shaft of the pulse motor 9 and is rotationally driven by the pulse motor 9. The idling pulley 11 is provided at the side opposite to the driving pulley 10 in the width direction of the printer main body 5. The timing belt 12 is stretched upon between the driving pulley 10 and the idling pulley 11 and is connected to the carriage 4.

Under such configuration, the carriage 4 reciprocates in the main scanning direction along the guiding shaft 8 by driving the pulse motor 9.

Further, the sheet feeding mechanism 66 is constituted by a sheet feeding motor, a sheet feeding roller (which are not illustrated), and the like. The sheet feeding roller is rotationally driven by the sheet feeding motor. The sheet feeding mechanism 66 interlocks a recording sheet with a recording (printing) operation so as to sequentially feed the recording sheet onto a platen.

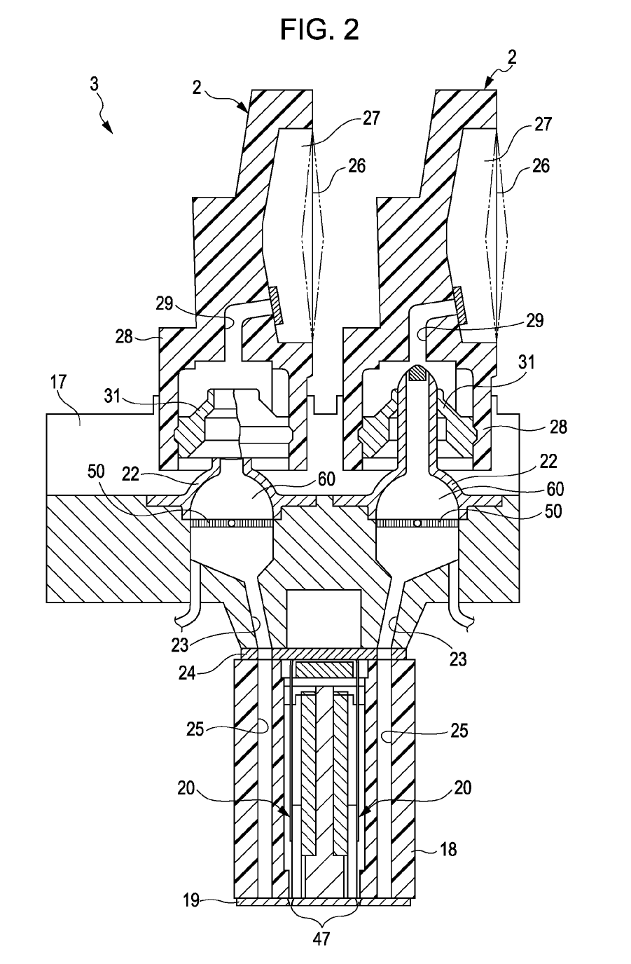

FIG. 2 is a cross-sectional view for explaining a configuration of a recording head in the printer 100 according to the embodiment.

As illustrated in FIG. 2, the recording head 3 in the embodiment includes an introducing needle unit 17, a head case 18, a flow path unit 19, and actuator units 20 as main components.

Two ink introducing needles 22 are attached side by side to an upper surface of the introducing needle unit 17 in a state where filters 50 are interposed. Each sub tank 2 is mounted on each ink introducing needle 22. Further, ink introducing paths 23 each of which corresponds to each ink introducing needle 22 are formed in the introducing needle unit 17.

In the embodiment, since a configuration in which two types of inks are used is employed, two sub tanks 2 are arranged. However, it is needless to say that the invention can be applied to a configuration in which three or more types of inks are used.

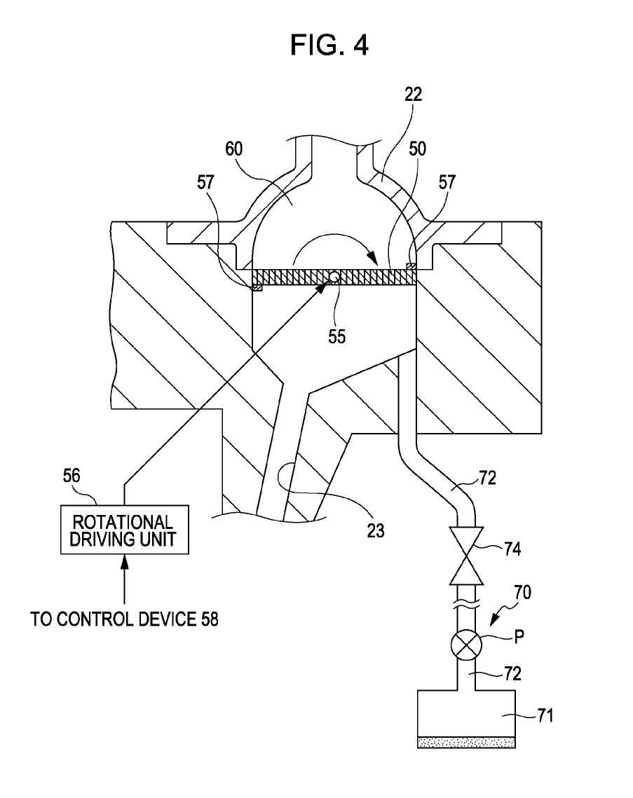

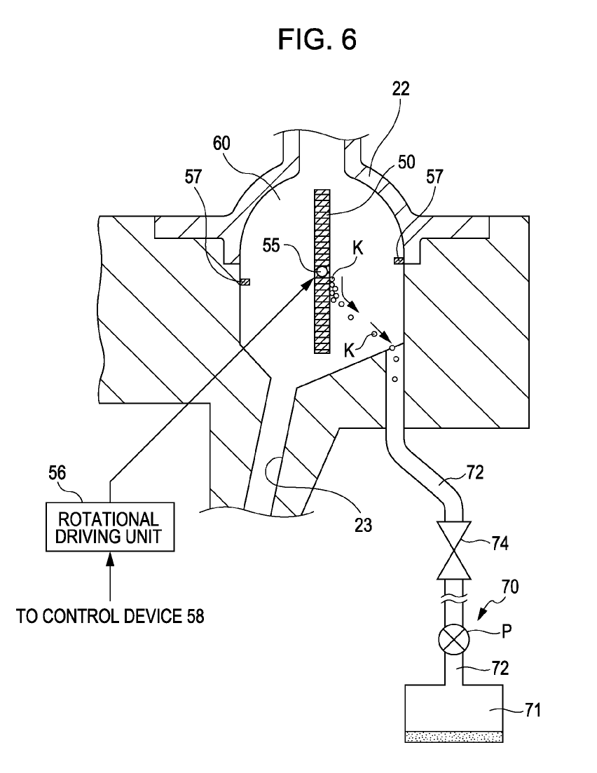

Each ink introducing path 23 is communicated with each ink introducing needle 22 through a filter chamber 60 which is provided on an upper end of the ink introducing path 23. Further, a lower end of each ink introducing path 23 is communicated with a case flow path 25 formed in the head case 18 through a packing 24. Each filter 50 is rotatably attached to each filter chamber 60 (see, FIGS. 4 and 6).

Each sub tank 2 is molded by a resin material such as polypropylene. A concave portion serving as an ink chamber 27 is formed in each sub tank 2 and a transparent elastic sheet 26 is bonded to an opening surface of the concave portion so that the ink chamber 27 is partitioned.

Further, a needle connecting portion 28 into which each ink introducing needle 22 is inserted is provided in a lower portion of each sub tank 2 so as to project downward. Each ink chamber 27 in each sub tank 2 is formed into a shallow mortar shape. An upstream-side opening of a connecting flow path 29 is connected to each ink chamber 27 at a position slightly lower than the center of a side face thereof in the vertical direction. The connecting flow path 29 communicates each ink chamber 27 and each needle connecting portion 28. Further, a tank filter (not illustrated) is provided at the upstream side of each ink chamber 27. A sealing member 31 into which each ink introducing needle 22 is fitted in a liquid-sealed manner is fitted into an internal space of each needle connecting portion 28.

An ink flow-in port (not illustrated) which is communicated with each ink chamber 27 is provided in each sub tank 2 in a projection manner. An ink supply tube 34 for supplying ink stored in each ink cartridge 6 is connected to the ink flow-in port so that the ink passing through the ink supply tube 34 flows into the ink chamber 27. The printer 100 according to the embodiment includes two ink cartridges 6 each of which is connected to each corresponding sub tank 2 through each ink supply tube 34. It is to be noted that the number of ink cartridges 6 is not limited to two.

Each elastic sheet 26 as illustrated in FIG. 2 can deform in the directions of contracting and expanding each ink chamber 27. Further, pressure fluctuation of ink is absorbed with a damper function by the deformation of each elastic sheet 26. That is to say, each sub tank 2 functions as a pressure damper by the effect of the elastic sheet 26. Accordingly, ink is supplied to the side of the recording head 3 in a state where the pressure fluctuation of ink is absorbed in each sub tank 2.

The head case 18 is a hollow box-shaped member made of a synthetic resin. The head case 18 is configured as follows. The flow path unit 19 is bonded to a lower end surface of the head case 18 and the actuator units 20 are accommodated in an accommodating hollow portion 37 formed in the head case 18. Further, the introducing needle unit 17 is attached to an upper end surface of the head case 18 at the side opposite to the flow path unit 19 with the packing 24 being interposed.

The case flow paths 25 are provided in the head case 18 so as to penetrate through the head case 18 in the height direction. An upper end of each case flow path 25 is communicated with each ink introducing path 23 of the introducing needle unit 17 through the packing 24.

Further, a lower end of each case flow path 25 is communicated with a common ink chamber 44 in the flow path unit 19. Accordingly, ink introduced from each ink introducing needle 22 is supplied to the common ink chamber 44 through the ink introducing path 23 and the case flow path 25.

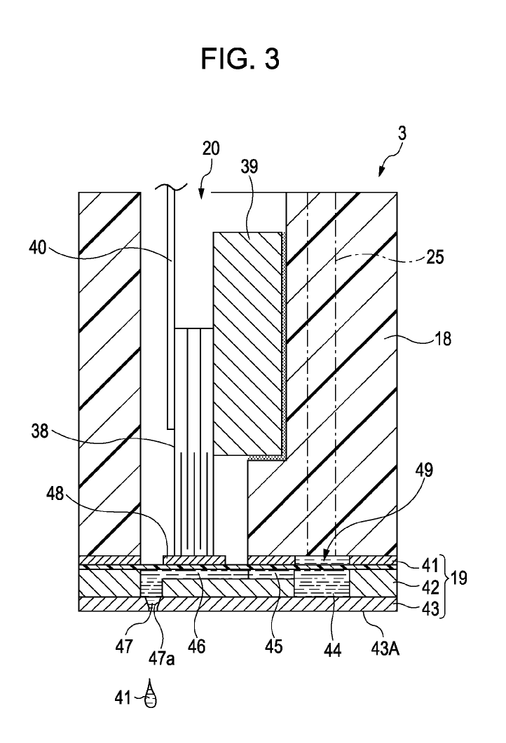

FIG. 3 is a plan view schematically illustrating a configuration of main parts around the recording head 3 for explaining the embodiment.

As illustrated in FIG. 3, the recording head 3 includes the head case 18 made of a synthetic resin. Further, the flow path unit 19 is bonded to the lower end surface of the head case 18, the actuator units 20 are accommodated in the head case, and the ink introducing paths 23 are connected to the upper end surface of the head case 18 at the side opposite to the flow path unit 19.

The case flow paths 25 are provided in the head case 18 so as to penetrate through the head case 18 in the height direction. An upper end of each case flow path 25 is communicated with each ink introducing path 23 and a lower end thereof is communicated with each common ink chamber 44 in the flow path unit 19. Accordingly, ink introduced from each ink introducing path 23 is supplied to the common ink chamber 44 through the case flow path 25.

Each actuator unit 20 is constituted by a plurality of piezoelectric vibrators 38, a fixing plate 39, and a flexible cable 40. The plurality of piezoelectric vibrators 38 are arranged in a row in a comb-tooth form. The fixing plate 39 is bonded to the piezoelectric vibrators 38. The flexible cable 40 serves as a wiring member which supplies a driving signal from the side of the printer main body to the piezoelectric vibrators 38. A fixed end of each piezoelectric vibrator 38 is bonded onto the fixing plate 39 and a free end thereof projects outward with respect to a tip surface of the fixing plate 39. That is to say, each piezoelectric vibrator 38 is attached to the fixing plate 39 in a so-called cantilever state.

The fixing plate 39 which supports the piezoelectric vibrators 38 is formed with a stainless steel having a thickness of approximately 1 mm, for example.

A rear surface of the fixing plate 39 is adhered to a case inner wall surface partitioning the accommodating hollow portion 37 so that each actuator unit 20 is accommodated in and fixed to the accommodating hollow portion 37.

The flow path unit 19 is a member formed as follows. That is, flow path unit constituent members including a vibration plate 41, a flow path substrate 42 and a nozzle substrate 43 are integrally formed in a state where the flow path unit constituent members are stacked on one another. The flow path unit 19 forms a series of an ink flow path from the common ink chamber 44 to nozzle openings 47a through ink supply ports 45 and pressure chambers 46. Each pressure chamber 46 is formed into a chamber elongated in the direction perpendicular to the direction in which the nozzle openings 47a are arranged in a row (nozzle row direction). Each pressure chamber 46 includes the piezoelectric vibrator 38 corresponding thereto.

Each common ink chamber 44 is a chamber which is communicated with each ink introducing path 23 and to which ink from the side of each sub tank is introduced. The ink introduced to the common ink chamber 44 is distributed and supplied to each pressure chamber 46 through each ink supply port 45.

The nozzle substrate 43 arranged on the bottom of the flow path unit 19 is a thin plate made of a metal. The plurality of nozzle openings 47a are opened on the nozzle substrate 43 in a row at a pitch (for example, 180 dpi) in accordance with a dot formation density. The plurality of nozzle openings 47a are formed on a surface of the nozzle substrate 43 and the nozzle openings 47a are configured by such surface of the nozzle substrate 43 on which the nozzle openings 47a are formed. That is to say, the surface of the nozzle substrate 43 forms a nozzle formation surface 43A on which the plurality of nozzle openings 47a are formed.

The flow path substrate 42 is manufactured by subjecting a silicon wafer as a base material having a crystal structure to an anisotropic etching processing. The vibration plate 41 is a composite plate material having a double layered structure. To be more specific, the vibration plate 41 is obtained by laminating an elastic film on a support plate made of a metal such as a stainless steel. The support plate is removed in a circular-band shape by etching or the like at portions of the vibration plate 41, which correspond to the pressure chambers 46, so that island portions 48 to which tip surfaces of the piezoelectric vibrators 38 are bonded are formed. The portions from which the support plate is removed function as diaphragm portions. That is to say, the vibration plate 41 is configured such that the elastic film around the island portion 48 is elastically deformed in accordance with operations of the piezoelectric vibrators 38.

Further, the vibration plate 41 seals one opening surface of the flow path substrate 42 and also functions as a compliance portion 49. The support plate is removed by etching or the like and only the elastic film is formed as in the diaphragm portion at a portion corresponding to the compliance portion 49.

In such recording head 3, if driving vibration is supplied to the piezoelectric vibrators 38 through the flexible cable 40, the piezoelectric vibrators 38 expand and contract in the element lengthwise direction. The island portion 48 is moved in the direction approaching to or separating from the pressure chambers 46 with the expansion or contraction of the piezoelectric vibrators 38. With this, volumes of the pressure chambers 46 are changed so as to generate pressure fluctuation in ink in the pressure chambers 46. Ink droplets D are discharged through the nozzles 47 with the pressure fluctuation.

The capping mechanism 14 is constituted by a cap member 15, a suction pump (not illustrated) and the like. The cap member 15 is formed with a member obtained by molding an elastic material such as rubber into a tray shape, and is arranged at a home position. It is to be noted that the cap member 15 abuts against the nozzle formation surface 43A of the nozzle substrate 43 in a state where the cap member 15 covers a nozzle formation region on the recording head 3. The home position is set to locate in a movement range of the carriage 4 at an end region at the outer side with respect to a recording region. The carriage 4 is positioned at the home position when a cleaning processing is performed on the recording head 3.

At the time of the cleaning processing of the recording head 3, the processing is performed in a state where the carriage 4 is positioned at the home position and the cap member 15 abuts against and seals the nozzle formation surface 43A of the nozzle substrate 43 of the recording head 3. In the embodiment, the cleaning processing includes a so-called suction processing of forcibly discharging ink through each nozzle 47 of the recording head 3 so as to maintain or recover discharge property of the head.

As will be described in detail, at the time of the cleaning processing (suction processing), a suction pump 16 is operated in a sealing state so as to decompress an inner portion (sealed hollow portion) of the cap member 15. Therefore, ink in the recording head 3 is forcibly discharged through the nozzles 47 as ink droplets. At this time, ink droplets are discharged through all the nozzles 47 of the recording head 3.

Further, the wiping member WP is used at the time of a wiping processing of wiping out ink attached to the nozzle formation surface 43A with the suction operation by the capping mechanism 14. The wiping member WP is formed with an elastic member such as elastomer, for example.

FIG. 4 is a view illustrating an arrangement state of the filter 50 in the filter chamber 60. FIG. 5 is a block diagram illustrating an electric configuration of the printer 100. FIG. 6 is a view illustrating an operation state of the filter 50.

As illustrated in FIG. 4, the filter 50 allows ink to pass therethrough and captures forein materials (substances) present in ink. Further, the filter 50 is rotatably attached to an inner wall surface of the ink introducing needle 22 through a supporting shaft 55. A rotational driving unit 56 which rotates the supporting shaft 55 is provided on the supporting shaft 55. Ends of the filter 50 are supported by stoppers 57 and the filter 50 is rotatable only in the clockwise direction in FIG. 4.

To be more specific, the filter 50 is obtained by punching a large number of through-holes in a flat base material of a stainless steel (SUS) and cutting the base material into a square shape when seen from the above. A plate thickness of the filter 50 is approximately 10 through 20 μm, and the width of the through-holes along a diagonal line is approximately 10 through 20 μm. It is to be noted that an opening area of each through-hole is set depending on the thickness of the base material, types of ink, and the like. The shape of the through-holes (openings) when seen from the above is not limited to the square shape and may be other shapes such as a circular shape, an elliptical shape, a diamond shape and so on.

The printer 100 in the embodiment includes a control device 58 which controls the entire operations of the printer 100. An input device 59, a storage device 63 and a measurement device 61 are connected to the control device 58. The input device 59 inputs various pieces of information relating to operations of the printer 100. The storage device 63 stores various pieces of information relating to the operations of the printer 100. The measurement device 61 can execute time measurement.

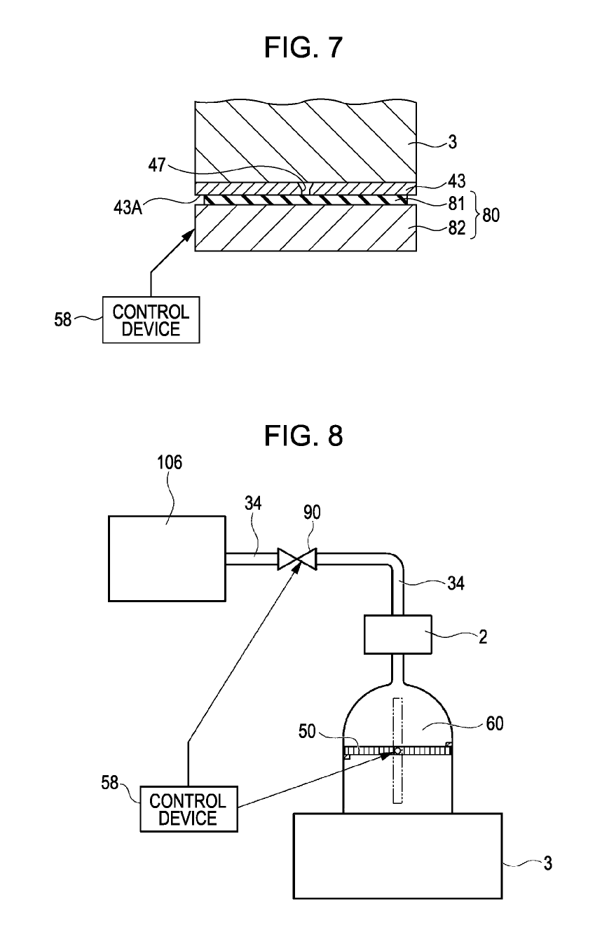

Further, the sheet feeding mechanism 66, the carriage movement mechanism 65, the capping mechanism 14, the rotational driving units 56 (which are described above), decompression devices (see, FIG. 6) 70, an abutment unit (see, FIG. 7) 80, and the like are connected to the control device 58. Further, the printer 100 includes a driving signal generator 62 which generates a driving signal to be input to the piezoelectric vibrators 38. The driving signal generator 62 is connected to the control device 58.

Data indicating a change amount of a voltage value of a discharge pulse input to the piezoelectric vibrators 38 of the recording head 3 and a timing signal defining a timing at which a voltage of the discharge pulse is changed are input to the driving signal generator 62. The driving signal generator 62 generates a driving signal including a discharge pulse based on the input data and timing signal. With this, a predetermined amount of ink droplets is discharged through the nozzles 47.

The control device 58 judges whether the printer 100 is in a printing mode or in a non-printing mode. The control device 58 drives each rotational driving unit 56 to control the position of each filter 50 based on the judgment result. To be more specific, when the printer 100 is in the printing mode, the control device 58 does not drive each rotational driving unit 56 such that each filter 50 in each filter chamber 60 is arranged horizontally, as illustrated in FIG. 4 (first state). That is, in such case, each filter 50 is made in a state where a foreign material removal function is carried out in each filter chamber 60.

Therefore, ink which has flown into each ink introducing needle 22 passes through the filter 50, and then, flows out to the ink introducing path 23 at the downstream side. When the ink passes through the filter 50, foreign materials (ink of which viscosity has been increased or which has been solidified, air bubbles, and the like) mixed in the ink are captured by the filter 50. Then, only ink having no foreign materials passes through the filter 50. Therefore, preferable ink can be discharged through the nozzles 47.

If foreign materials mixed in ink, particularly air bubbles, are accummulated on the filter 50, an ink flow path resistance is undesirably increased. Then, ink cannot be preferably supplied to the nozzles 47 through the recording head 3 (case flow path 25). This arises a risk that failure such as discharge failure through the nozzles 47 is caused.

In order to solve the above problem, the printer 100 according to the embodiment employs a configuration in which each filter 50 is rotatable in each filter chamber 60. The control device 58 drives each rotational driving unit 56 at a predetermined timing in the non-printing mode so as to rotate the filter 50 by 90 degrees to arrange the filter 50 in a substantially vertical state (second state), as illustrated in FIG. 6. The predetermined timing mentioned above is a timing at which a cleaning is performed or a timing immediately after each ink cartridge 6 is exchanged and before a printing processing is started, for example. That is to say, each filter 50 is made into a state where the foreign material removal function is not carried out in each filter chamber 60.

At this time, a flow of ink downward along a surface of each filter 50 is generated under its own weight. Therefore, air bubbles K attached to the surface of the filter 50 flow downward along the surface of the filter 50 by themselves or together with ink. It is to be noted that since the foreign materials removed by the filter 50 are captured by the filter 50, the foreign materials will hardly flow. Even if the foreign materials flow, the foreign materials can be preferably discharged to the outside by the decompression device 70, which will be described later. Therefore, there arises no problem. As described above, in the embodiment, the air bubbles which have flown along the filter 50 do not pass through the nozzles 47 of the recording head 3. This can suppress a problem from occurring that air bubbles remain in the flow path from the filter 50 to the nozzles 47 to cause discharge failure thereafter. In addition, since the air bubbles do not pass through a narrow flow path without passing through the nozzles 47, the air bubbles can be discharged more easily.

The flow of ink along the filter 50 means not only a flow parallel with the surface of the filter 50 but also a flow having an angle within a predetermined range with respect to the surface. It is to be noted that a rotational angle of the filter 50 (angle of the filter 50 with respect to an arrangement surface before rotated) is not limited to 90 degrees and may be approximately 45 degrees. It is sufficient that the rotational angle is set to be an angle at least to the extent that the flow of ink containing air bubbles along the surface of the filter 50 is generated when the filter 50 is rotated.

Further, the printer 100 includes the decompression devices (discharge units) 70 which decompress inner portions of the filter chambers 60. Each decompression device 70 is configured to drive when the filter 50 is rotated to be in the stated substantially vertical state. Each decompression device 70 includes a suction pump P which is connected to each filter chamber 60 through a tube 72 and a waste ink tank 71. The tube 72 is connected to the filter chamber 60 via a check valve 74. Therefore, waste ink in each waste ink tank 71 can be prevented from flowing in the opposite direction.

Further, the printer 100 includes the abutment unit 80 which abuts against the nozzle formation surface 43A of the recording head 3 when the above decompression devices 70 are driven. FIG. 7 is a schematic view illustrating the configuration of the abutment unit 80. As illustrated in FIG. 7, the abutment unit 80 includes an abutment portion 81 and a driving portion 82. The abutment portion 81 abuts against the nozzle formation surface 43A. The driving portion 82 drives the abutment portion 81 so as to approach to or separate from the nozzle formation surface 43A. The driving portion 82 is electrically connected to the control device 58 so that the driving thereof is controlled. The abutment portion 81 is formed with an elastic member such as rubber, for example, and makes close contact with the nozzle formation surface 43A preferably. Therefore, the abutment unit 80 makes the abutment portion 81 abut against the nozzle formation surface 43A so as to be capable of sealing the nozzles 47.

In the embodiment, the nozzles 47 are closed in a sealing manner with the above abutment portion 81. Therefore, the above decompression devices 70 are driven in a state where ink flow paths of the recording head 3 are closed. Each decompression device 70 drives the suction pump P to decompress the inner portion of each filter chamber 60 so that ink flowing along the surface of the filter 50 can be preferably discharged to the waste ink tank 71 through the tube 72. Further, since the nozzles 47 are closed in a sealing manner, a problem that meniscuses in the nozzles 47 are drawn and broken can be prevented from occurring. It is to be noted that a configuration in which an atmosphere releasing valve (not illustrated) is provided on each filter chamber 60 may be employed. In the configuration, when the inner portion of the filter chamber 60 is decompressed by the suction pump P, the atmosphere releasing valve is opened so as to push out ink attached to each filter 50 with air flow which has entered each filter chamber 60.

Further, each suction pump P may be set such that a suction force thereof is equal to or lower than a meniscus withstanding pressure of the nozzles 47. If the suction pump P is set in this manner, air bubbles attached to each filter 50 can be discharged while preventing breakage of the meniscuses of the nozzles 47 due to the suction operation by the suction pump P from occurring. Therefore, discharge failure is prevented from occurring so that the printing processing can be continuously performed after each decompression device 70 is driven. In addition, since the meniscuses of the nozzles 47 are not broken after the decompression device 70 has been driven, a flushing operation for adjusting the meniscuses is not required to be performed, thereby reducing a consumption amount of ink.

As described above, with the printer 100 according to the embodiment, the decompression devices 70 are driven while the control device 58 rotates the filters 50 at a predetermined timing in the non-printing mode so that air bubbles attached to the filters 50 can be discharged to the outside. Therefore, a problem that air bubbles are accumulated on the filters 50 to increase the flow path resistance so that ink is not preferably supplied to the recording head 3 from the ink cartridges 6 can be prevented from occurring. Accordingly, discharge failure of ink is prevented from occurring. Further, the air bubbles attached to the filters 50 can be selectively discharged by driving the decompression devices 70. This makes it possible to prevent ink from being discharged at an amount more than necessary as an existing choke cleaning performed for discharging air bubbles.

### Variations

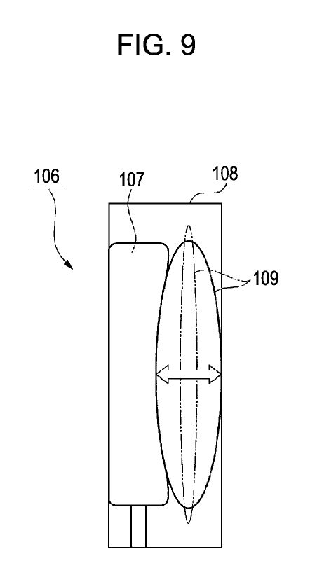

Next, the configuration of a printer according to a variation is described. The printer according to the variation is configured such that ink in the ink cartridges 6 is press-transferred so as to supply ink to the recording head 3. It is to be noted that the same reference numerals denote the same configuration as the above embodiment and detailed description is not repeated. FIG. 8 is a schematic view illustrating a flow path system of ink according to the variation. FIG. 9 is a view illustrating a configuration in an ink cartridge 106.

As illustrated in FIG. 8, in the variation, a pressure adjusting valve 90 is provided on the ink supply tube 34 connected to the ink cartridge 106 and the sub tank 2. Therefore, if ink is discharged through the nozzles 47 of the recording head 3, pressure in the sub tank 2 is lowered and the above pressure adjusting valve 90 is opened so that ink is press-transferred to the side of the sub tank 2 from the ink cartridge 106. It is to be noted that the above pressure adjusting valve 90 is electrically connected to the control device 58.

The ink cartridge 106 includes an ink pack 107 and a case member 108 which accommodates the ink pack 107 as illustrated in FIG. 9. To be more specific, a balloon pack (pressurizing mechanism) 109 and the ink pack 107 are accommodated in the case member 108. The balloon pack 109 can expand by supplying air thereto from the outside as illustrated in solid lines in FIG. 9 or contract by discharging the supplied air.

It is to be noted that a space is generated between the case member 108 and the ink pack 107 in a state where the balloon pack 109 is not expanded. That is to say, the balloon pack 109 is expanded in the space so that the balloon pack 109 presses the ink pack 107. Further, the ink pack 107 is returned to an initial state by discharging air in the balloon pack 109. Based on the configuration, air is supplied to the balloon pack 109 so that the balloon pack 109 presses the ink pack 107, thereby press-transferring ink from the ink cartridge 106.

The control device 58 drives each rotational driving unit 56 only in the non-printing mode (for example, at a timing at which cleaning is performed or at a timing at which each ink cartridge 6 is exchanged). Then, as illustrated in FIG. 6, the control device 58 rotates each filter 50 by 90 degrees and arranges the filter 50 in a substantially vertical state (second state).

In the variation, air bubbles attached to each filter 50 are discharged to the outside by using a pressurizing force applied to the above ink pack 107 in a state where each filter 50 is rotated in place of using the above decompression device 70. As a discharge unit for discharging the air bubbles to the outside, a configuration in which the suction pump is eliminated from each decompression device 70 can be employed as it is.

If each filter 50 is rotated, air bubbles attached to the surface of the filter 50 flows downward along the surface of the filter 50 by themselves or together with ink. In the variation, ink is press-transferred from the ink pack 107 in a state where the nozzles 47 are closed in a sealing manner by the above abutment portion 81. It is to be noted that the above pressure adjusting valve 90 is forcibly opened in a state where the control device 58 rotates each filter 50. The driving portion 82 of the abutment unit 80 is driven to make the abutment portion 81 abut against the nozzle formation surface 43A so that the nozzles 47 are closed in a sealing manner. Therefore, the meniscuses of the nozzles 47 can be prevented from being broken as in the above embodiment.

Accordingly, the pressurizing force applied to the ink pack 107 is transmitted to ink in the filter chamber 60 from the pressure adjusting valve 90 through the sub tank 2. Then, the ink flows through the surface of the filter 50 so as to be discharged to the waste ink tank 71 through the tube 72 together with the air bubbles K.

As described above, according to the variation, the air bubbles K attached to the filter 50 can be discharged to the outside by using the flow of ink press-transferred from the ink cartridge 106 with the pressurizing force by the balloon pack 109. Therefore, a problem that air bubbles are accumulated on the filter 50 to increase the flow path resistance so that ink is not preferably supplied to the recording head 3 from the ink cartridge 6 can be prevented from occurring. Accordingly, discharge failure of ink is prevented from occurring. Further, since the suction pump P can be eliminated from the configuration of each decompression device 70, reduction in size and cost can be realized. It is to be noted that in the variation, the pressurizing force by the balloon pack 109 may be set to be equal to or lower than a meniscus withstanding pressure of the nozzles 47 in place of using the above abutment portion 81. If the above configuration is employed, breakage of the meniscuses due to ink pressed-out from the nozzles 47 at the time of the pressurizing can be prevented from occurring even if the abutment portion 81 is not provided.

Hereinbefore, a preferable embodiment of the invention has been described with reference to the accompanying drawings. However, it is needless to say that the invention is not limited to the embodiment. It is obvious that various changes or variations can be made by those skilled in the art within the range of the technical spirit described in the scope of the invention. Further, it is understood that the changes or variations are also emcompassed in the technical range of the invention, of course.

In the above embodiment and variation, a case where air bubbles or ink containing air bubbles which has flown from the surfaces of the filters 50 inclined by rotation are discharged directly to the outside from the filter chambers 60 has been described. However, the invention is not limited thereto. For example, the filters 50 may be rotated when the suction operation by the capping mechanism 14 is performed so that air bubbles are discharged through the nozzles 47 along with the suction operation. In this case, if the filters 50 are rotated, the air bubbles attached to the filters 50 can be discharged easily. Therefore, air bubbles can be discharged to the outside without requiring a strong suction force by using the suction operation by the capping mechanism 14 or the like as the existing choke suction. Therefore, the choke suction operation for discharging the air bubbles is not required, thereby largely suppressing a consumption amount of ink when the air bubbles are discharged.

In the above embodiment, an ink jet printer is employed. However, a liquid ejecting apparatus which ejects and discharges liquids other than ink may be employed. The invention can be applied to various types of liquid ejecting apparatuses including a liquid ejecting head or the like which discharges a trace amount of liquid droplets. Note that the term “liquid droplets” represents the state of liquid which is discharged from the above liquid ejecting apparatus. For example, a granule form, a teardrop form, and a form that pulls tails in a string-like form therebehind are included as the liquid droplets. The term “liquid” here represents materials which can be ejected by the liquid ejecting head. For example, any materials are included as long as the materials are in a liquid phase. For example, materials in a liquid state having high viscosity or low viscosity, or a fluid state such as sol, gel water or other inorganic solvents, an organic solvent, a solution, a liquid resin, or a liquid metal (molten metal) can be included as the liquid. Further, the liquid is not limited to liquid as one state of a material but includes a liquid in which particles of a functional material made of a solid material such as pigment or metal particles are dissolved, dispersed, or mixed in a solvent. Typical examples of the liquid are ink described in the above embodiment, liquid crystals, and the like. The term “ink” here encompasses various liquid compositions such as common aqueous ink and oil ink, gel ink and hot melt ink. Specific examples of the liquid ejecting apparatus include a liquid ejecting apparatus that ejects liquid in which a material such as an electrode material or a coloring material is dispersed or dissolved. The material such as the electrode material or the coloring material is used for manufacturing liquid crystal displays, electroluminescence (EL) displays, surface light emitting displays and color filters, for example. Further, the specific examples of the liquid ejecting apparatus include a liquid ejecting apparatus which ejects a bioorganic material used for manufacturing biochips, a liquid ejecting apparatus which ejects liquid serving as a sample and is used as a precision pipette, printing equipment, and a micro-dispenser. Further, other examples of the liquid ejecting apparatus include a liquid ejecting apparatus which pinpoint-ejects lubricating oil to a precision machine such as a watch or a camera. Further, a liquid ejecting apparatus which ejects a transparent resin solution of an ultraviolet curable resin or the like onto a substrate in order to form a hemispherical microlens (optical lens) used for an optical communication element and the like is included as the liquid ejecting apparatus. In addition, a liquid ejecting apparatus which ejects an acid or alkali etching solution for etching a substrate or the like may be employed as the liquid ejecting apparatus. The invention can be applied to any one type of the liquid ejecting apparatuses mentioned above.

What is claimed is:

1. A liquid ejecting apparatus comprising:
a liquid ejecting head which ejects liquid through nozzles;
a liquid accommodating portion which accommodates the liquid to be supplied to the liquid ejecting head; and
a filter chamber which is arranged in a liquid supply path between the liquid ejecting head and the liquid accommodating portion and includes a rotatable filter.

2. The liquid ejecting apparatus according to claim 1,
wherein the filter is rotatable in the filter chamber between a first state in which the liquid passes through the filter and a second state in which the liquid flows along the filter.

3. The liquid ejecting apparatus according to claim 2, further including a discharge unit which is arranged between the filter and the liquid ejecting head and discharges the liquid which has flown along the filter from the filter chamber in the second state.

4. The liquid ejecting apparatus according to claim 3,
wherein the filter chamber includes a flow path communicating with the liquid ejecting head and a flow path communicating with the discharge unit at the downstream side of the filter chamber, and
wherein, in the first state, an upstream-side surface of the filter faces to the side of the flow path communicating with the discharge unit in the second state.

5. The liquid ejecting apparatus according to claim 4,
wherein the discharge unit includes a suction pump which decompresses an inner portion of the filter chamber and sucks the liquid in the second state.

6. The liquid ejecting apparatus according to claim 4, further including a pressurizing mechanism which applies a pressurizing force to the liquid accommodated in the liquid accommodating portion,
wherein the discharge unit discharges the liquid from the filter chamber by using the pressurizing force by the pressurizing mechanism in the second state.

7. The liquid ejecting apparatus according to claim 5, further including an abutment unit which abuts against a nozzle formation surface of the liquid ejecting head on which the nozzles are formed in the second state.

8. The liquid ejecting apparatus according to claim 5,
wherein a suction force by the suction pump is set to be equal to or lower than a meniscus withstanding pressure of the nozzles.

9. The liquid ejecting apparatus according to claim 6,
wherein a pressurizing force by the pressurizing mechanism is set to be equal to or lower than a meniscus withstanding pressure of the nozzles.
